(19) United States
(12) Patent Application Publication
(10) Pub. No.: US 2026/0176475 A1
(43) Pub. Date: Jun. 25, 2026

(54) TREATMENT FOR PROTECTING PRODUCE FROM SUPERFICIAL SCALD AND/OR SCUFFING DAMAGE

(71) Applicant: NABACO INC., San Marcos, TX (US)

(72) Inventor: Gary BEALL, San Marcos, TX (US)

(21) Appl. No.: 18/840,828

(22) PCT Filed: Mar. 13, 2024
(86) PCT No.: PCT/IB2024/052430

§ 371 Date: Aug. 22, 2024

Related U.S. Application Data
(60) Provisional application No. 63/451,805, filed on Mar. 13, 2023.
(60) Provisional application No. 63/451,813, filed on Mar. 13, 2023.

(51) Int. Cl. C09D 5/04; A23B 7/154; A23B 7/157; A23B 7/16; C09D 7/20; C09D 7/48; C09D 7/62; C09D 7/63; C09D 105/00; C09D 105/06

(52) U.S. Cl. CPC C09D 5/04; A23B 7/154; A23B 7/157; A23B 7/16; C09D 7/20; C09D 7/48; C09D 7/62; C09D 7/63; C09D 105/00; C09D 105/06

(57) ABSTRACT

A thixotropic aqueous mixture for preventing superficial scald and/or scuffing damage on produce, such as fruit or pome fruits, and an application method thereof comprising at least one smectite clay and a water-soluble polymer, wherein the thixotropic aqueous mixture is added with high shear mixing to water then applied to produce, such as fruit or pome fruit, via a dip tank, spray bar, or brush bed or combination thereof.

### FIELD OF THE INVENTION

The present invention is directed to a composition that is effective for protecting produce from scald and/or scuffing, for example wherein the produce is fruit, such as pome fruits (e.g., pears). The composition is or comprises a thixotropic aqueous mixture comprising at least one smectite clay and at least one water-soluble polymer. The invention also relates to a method for preparing the composition, a method for coating produce, such as fruit or pome fruits (e.g., pears), comprising applying the coating composition to the produce, and methods and uses of the composition for protecting produce, such as fruit, from superficial scald damage and/or scuffing damage.

### BACKGROUND OF THE INVENTION

Pome fruits, such as pears and apples, are often stored for long periods of time in a controlled atmosphere at temperatures close to freezing. During this prolonged storage period, the fruit develops brown to black discoloration on the skin of the fruit. This discoloration is referred to as superficial scald. The current physiology of the scald appears to be related to the build-up of alpha farnesenes that are oxidized to trienols. This oxidation appears to be triggered by ambient oxygen. It appears that the majority of scald occurs on the shaded side of the fruit. This might be due to the plants' response to sunlight and the buildup of antioxidants as a protection against the suns deleterious effects.

It has recently been demonstrated that the coating of fruit with squalene lowers superficial scald. Squalene is a naturally occurring polyunsaturated hydrocarbon that has antioxidant properties. It however is an oil and therefore imparts an unpleasant oily feel to the fruit.

Currently there are no coatings available for preventing superficial scald on produce, such as fruit, that also do not negatively modify the produce. Thus, a need exists for a composition that protects against (and may even prevent) superficial scald on produce, such as fruit, that does not negatively modify the produce. For coating organic produce, such as organic fruit, in order to maintain the organic status of the produce, there is a further need for a composition that is not only edible but organic.

Another prominent type of damage to produce, particularly fruit, is scuffing. Scuffing is an abrasion that appears on the surface of produce from rubbing against surfaces or a bruise from impact. Scuffing on pome fruit such as pears appears as brown spots or streaks. These scuff marks make the fruit less appealing to the consumer and decrease its value. Scuffing damage increases as the fruit ripens.

Pears are unique in the pome fruit category in that the skin is very fragile. The skins of pears are very susceptible to damage in the normal course of harvest, sorting and packing. In many cases, pears are kept in cold storage for several months in field bins before being packed as dictated by retail demand. The amount of scuffing increases the longer the pears are kept in storage. It is also common practice to utilize ethylene treatment to accelerate ripening of pears. This process increases the pears' susceptibility to scuffing. Compositions that aid pear processing known in the art are inorganic and affect the edibility of pears after coating. Thus, a need exists for a composition that prevents scuffing on pears and other produce, which is edible and, for organic produce, also organic.

### SUMMARY OF THE INVENTION

The invention relates generally to a composition that consists of or comprises a thixotropic mixture. Accordingly, the compositions of the invention are thixotropic compositions. The terms “thixotropic mixture” and “thixotropic composition” (or more specifically, “thixotropic aqueous mixture” and “thixotropic aqueous composition”) are used interchangeably herein to refer to compositions and mixtures of the invention that are thixotropic.

According to a first aspect of the present invention, there is provided a novel thixotropic mixture, which is a thixotropic aqueous mixture comprising at least one smectite clay and a water-soluble polymer.

In some embodiments, the smectite clay is hydrophobically modified (e.g., hydrophobic). In some embodiments, the water-soluble polymer is a natural water-soluble polymer. In one embodiment, the thixotropic aqueous mixture comprises at least one smectite clay (which may be a hydrophobically-modified (e.g., hydrophobic) smectite clay) and a water-soluble polymer (such as a natural water-soluble polymer), and further comprises an antioxidant (which may be a natural antioxidant and/or a food grade antioxidant, such as a natural antioxidant oil), and/or a solvent (which is typically a food grade solvent). For example, in one embodiment, the thixotropic aqueous mixture comprises at least one smectite clay (which may be a hydrophobically-modified smectite clay) and a natural water-soluble polymer, and further comprises an antioxidant selected from a natural and a food grade antioxidant, and/or a food grade solvent.

As described herein, when applied to the surface of produce, the thixotropic aqueous mixture of the invention forms a thin coating on the surface, which acts to protect the produce from superficial scald damage and/or scuffing damage (e.g., prevents superficial scald damage and/or scuffing damage). Accordingly, a thixotropic aqueous mixture of the invention is suitable and effective for protecting produce from scuffing damage and/or superficial scald damage. The thixotropic aqueous mixture is particularly well suited for protecting fruit, such as pome fruit (e.g., apples or pears).

The invention also provides methods of making a thixotropic aqueous mixture of the invention, and thixotropic aqueous mixtures made by the methods of the invention. The methods generally comprise mixing smectite clay and water-soluble polymer with water under high shear. In some aspects of the invention, all components of the composition are mixed together under high shear.

Therefore, according to a second aspect of the invention, there is provided a method of making a thixotropic aqueous mixture comprising at least one smectite clay (which may be hydrophobically-modified (e.g., hydrophobic) smectite clay) and a water-soluble polymer (such as a natural water-soluble polymer). The method comprises mixing at least one smectite clay and water-soluble polymer with solvent under high shear mixing conditions. The solvent typically comprises water, and may consist of water. In some embodiments, the solvent comprises water and a volatile solvent such as ethanol (e.g., a mixture of water and ethanol). In some embodiments, the at least one smectite clay and the water-soluble polymer are added separately (at the same time, or sequentially) to the water, or to the water and ethanol, during high shear mixing. In other embodiments, the at least one smectite clay and the water-soluble polymer are premixed in powder form before mixing with the water, or with the water and ethanol.

In some embodiments, after making the thixotropic aqueous mixture, the method further comprises applying said mixture to produce such as fruit (such as pome fruit, e.g., apples and pears).

According to a third aspect of the invention, there is provided a method of applying a thixotropic aqueous mixture comprising at least one smectite clay (which may be hydrophobically-modified (e.g., hydrophobic) smectite clay) and a water-soluble polymer (such as a natural water-soluble polymer) to produce, such as fruit or pome fruits (e.g., pears and apples). In some embodiments, the thixotropic aqueous mixture comprising the at least one smectite clay and the water-soluble polymer is applied to produce via a dip tank, spray bar, or brush bed, or a combination thereof. For example, the thixotropic aqueous mixture can be applied to produce via a combination of dip tank and brush bed. Alternatively, the thixotropic aqueous mixture can be applied to produce via a combination of spray bar and brush bed. In some embodiments, at least one smectite clay (e.g., hydrophobic/hydrophobically modified smectite clay) and a water-soluble polymer are mixed with solvent (e.g., water) under high shear to form a thixotropic aqueous mixture, as described herein, before being applied to the produce, such as fruit or pome fruit (e.g., pears and apples). The application of the thixotropic aqueous mixture of the invention to produce using these methods decreases superficial scald on the produce and/or decreases the susceptibility of the produce to scuffing.

According to a fourth aspect of the invention, there is provided a method comprising making a thixotropic aqueous mixture comprising at least one smectite clay (which may be a hydrophobic smectite clay (e.g., hydrophobically modified smectite clay)) and a water-soluble polymer (which may be a natural water-soluble polymer), the method comprising mixing the at least one smectite clay and the water-soluble polymer with solvent under high shear to form a thixotropic aqueous mixture; and then applying said mixture to produce, such as fruit or pome fruit (e.g., apples and pears). In some embodiments, the method comprises mixing at least one hydrophobically-modified (e.g., hydrophobic) smectite clay, a water-soluble polymer, and an antioxidant (which may be a natural antioxidant and/or a food grade antioxidant, such as a natural antioxidant oil) with solvent under high shear to form a thixotropic aqueous mixture, and then applying said mixture to produce. In some embodiments, the solvent consists of water, or the solvent may comprise water and a volatile solvent such as ethanol (e.g., a mixture of water and ethanol). In some embodiments, the method comprises applying the thixotropic aqueous mixture to the produce by a dip tank, spray bar, or brush bed, or a combination thereof. In some embodiments, the method comprises applying the thixotropic aqueous mixture to produce by a spray bar and brush bed. In some embodiments, the method comprises applying the thixotropic aqueous mixture to produce by a dip tank and brush bed. In some embodiments, the method further comprises subsequent drying of the solvent to evaporate the solvent.

In one embodiment, the method comprises mixing a hydrophobically-modified (e.g., hydrophobic) smectite clay, water-soluble polymer (such as a natural water-soluble polymer), and an antioxidant (e.g., a natural antioxidant and/or a food grade antioxidant, such as a natural antioxidant oil) under high shear with water to form a thixotropic fluid that can be applied to produce, such as fruit (e.g., pears), by a spray bar and brush bed with subsequent drying of the solvent. In one embodiment, the method comprises mixing a hydrophobically-modified (e.g., hydrophobic) smectite clay, water-soluble polymer (such as a natural water-soluble polymer), and an antioxidant (e.g., a natural antioxidant and/or a food grade antioxidant, such as a natural antioxidant oil) under high shear with water and ethanol (e.g., a mixture of water and ethanol) to form a thixotropic fluid that can be applied to produce, such as fruit (e.g., pears), by a spray bar and brush bed with subsequent drying of the solvent.

According to a fifth aspect, the invention provides a method of protecting produce from scuffing damage, comprising applying a thixotropic aqueous mixture of the invention to the surface of produce. In some embodiments, the method comprises applying the thixotropic aqueous mixture to the produce by a dip tank, spray bar, or brush bed, or a combination thereof; such as using a spray bar and brush bed, or using a dip tank and brush bed. In some embodiments, before applying the thixotropic aqueous mixture to the produce, the method comprises making the thixotropic aqueous mixture using a high shear method as described herein.

According to a sixth aspect, the invention provides a method of protecting produce from superficial scald damage, comprising applying a thixotropic aqueous mixture of the invention to the surface of produce. In some embodiments, the method comprises applying the thixotropic aqueous mixture to the produce by a dip tank, spray bar, or brush bed, or a combination thereof, such as using a spray bar and brush bed, or using a dip tank and brush bed. In some embodiments, before applying the thixotropic aqueous mixture to the produce, the method comprises making the thixotropic aqueous mixture using a high shear method as described herein.

According to a seventh aspect, the invention provides uses of a thixotropic aqueous composition of the invention for coating produce, for protecting produce from scuffing damage, and/or for protecting produce from superficial scald damage. The invention provides the use of a thixotropic aqueous mixture of the invention comprising at least one smectite clay (which may be a hydrophobically-modified (e.g., hydrophobic) smectite clay) and a water-soluble polymer (such as a natural water-soluble polymer) for protecting produce, such as fruit or pome fruit (e.g., pears), from scuffing damage and/or from superficial scald damage.

### BRIEF DESCRIPTION OF THE DRAWINGS

FIG. 1 depicts the percentage of superficial scald observed in “Nabaco Coated” Limonera pears, which are coated in a thixotropic aqueous mixture comprising 5% sodium montmorillonite, 1.5% Gum Arabic, and 0.2% sodium citrate in water, compared to “Control” Limonera pears, which are coated in carnauba wax, at six days post-application.

FIG. 2A-2B shows the degree of ripening and scuffing damage observed in “Nabaco Coated” pears, which are coated in a thixotropic aqueous mixture comprising 4.5% bentonite, 1.32% Gum Arabic, and 0.18% sodium citrate, compared to “Control” pears, which are coated in carnauba wax, at 9 days post-application.

FIG. 3 shows the degree of superficial scald observed in “Nabaco Coated” Granny Smith apples, which are coated in a thixotropic aqueous mixture comprising 4.3% bentonite, 1.9% pectin, and 0.18% sodium citrate, compared to “Control” Granny Smith apples, which are coated in carnuba wax, at 9 days post-application.

FIG. 4A-4B shows the degree of superficial scald of “Nabaco Coated” pears, which are coated in a thixotropic aqueous mixture comprising 4.5% bentonite, 1.32% Gum Arabic, and 0.18% sodium citrate, compared to “Control” pears, which are coated in carnauba wax, at 7 days post-application.

FIG. 5A-5B shows the degree of superficial scald observed in “Nabaco Coated” Bartlett pears, which are coated in a thixotropic aqueous mixture comprising 4.6% bentonite, 1.4% Gum Arabic, and 0.15% sodium citrate, compared to “Control” Bartlett pears, which are coated in carnauba wax, at 5 days post-application.

FIG. 6 depicts percentage scuffing observed in “Nabaco Coated” Bartlett pears, which are coated in a thixotropic aqueous mixture comprising 4.5% bentonite, 1.32% Gum Arabic and 0.18% sodium citrate, compared to “Control” Bartlett pears, which are coated in carnauba wax, measured at 1-, 3-, 5-, and 7-days post-application.

FIG. 7 depicts percentage scuffing results for “Nabaco Coated” D'Anjou pears, which are coated in a thixotropic aqueous mixture comprising 4.5% bentonite, 1.32% Gum Arabic and 0.18% sodium citrate, compared to “Control” D'Anjou pears, which are coated in carnauba wax, measured at 1-, 3-, 5-, and 7-days post-application.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

It has been unexpectedly discovered that certain water-soluble polymers and smectite clays form highly thixotropic fluids when mixed under high shear in water, and when applied to produce, such as fruit (e.g., apples or pears), these mixtures form a coating that protects the produce from superficial scald damage and/or scuffing damage to a large extent. In addition, the combination of smectite clay, water-soluble polymer, an antioxidant (e.g., a natural antioxidant and/or a food grade antioxidant, such as a natural antioxidant oil), and a solvent (typically a food-grade solvent) when mixed under high shear forms a thixotropic fluid that can subsequently be utilized to coat produce such as pome fruit (e.g., apples or pears) to protect against, and optionally prevent, superficial scald and/or scuffing damage. The presently disclosed invention provides a solution to the problems of superficial scald and/or scuffing damage of produce.

The thixotropy of the fluid is critical to the anti-scald and anti-scuffing phenomena. The high shear imparted in the mixing and/or application stage lowers the viscosity of the thixotropic aqueous mixture and lessens the resistance to flow. For example, when applying the coating mixture to produce using a spray bar, the shear imparted by the pump and spray nozzles lowers the viscosity of the aqueous thixotropic mixture and lessens the resistance to flow during spraying (i.e., the thixotropic mixture is thin when is it dispensed through the spray nozzle). Once the spray impinges upon the produce surface, the viscosity of the thixotropic aqueous mixture recovers, and the thixotropic aqueous mixture forms a fairly thick coating or film on the surface of the produce. The use of a brush bed is advantageous because this acts to further smooth out the coating on the produce, making the coating more comprehensive. Moreover, it reorientates the platelets of the smectite clay to be parallel to the surface of the produce (i.e., aligned with the surface of the produce). Thus, the brush bed reinforces the coating.

When the coated produce (e.g., fruit) encounters an abrasive surface(s), the thixotropic coating is sheared to a lower viscosity, which imparts lubricity to the surface thereby cutting down on scuffing. As processing and packaging occurs, the coating will dry to a uniform coating, which is preferably transparent, which renders the skin tougher and less prone to scuffing. It is difficult to determine with the naked eye which fruit has the coating. The individual components do not yield the same anti-scuffing effect.

In a first aspect, the invention provides a thixotropic mixture comprising at least one smectite clay and a water-soluble polymer. The thixotropic mixture is a thixotropic aqueous mixture. The thixotropic aqueous mixture is for protecting produce from (e.g., preventing) superficial scald and/or scuffing damage.

The term “thixotropic”, as used herein, refers to mixtures having non-Newtonian fluid dynamics whose flow properties, such as apparent viscosity, change with shear rate and duration of shear.

In some embodiments, the at least one smectite clay is montmorillonite, bentonite, hectorite, or Laponite (lithium sodium magnesium silicate, Na_{0.7}Si₈Mg_{5.5}Li_{0.3}O₂₀(OH)₄), or a mixture of any two thereof, any three thereof, or all four thereof. In some embodiments, the at least one smectite clay is selected from sodium montmorillonite, sodium bentonite, sodium hectorite, or Laponite, or a mixture of any two thereof, any three thereof, or all four thereof. For example, the smectite clay may be sodium montmorillonite or sodium bentonite.

In some embodiments, the thixotropic aqueous mixture comprises the at least one smectite clay in an amount from 1.0 to 7.0% wt. % (percentage of the total weight of the thixotropic aqueous mixture). In some embodiments, the thixotropic aqueous mixture comprises sodium montmorillonite in an amount from 1.0 to 7.0 wt. % (percentage of the total weight of the thixotropic aqueous mixture). In some embodiments, the thixotropic aqueous mixture comprises bentonite in an amount from 1.0 to 7.0% wt. % (percentage of the total weight of the thixotropic aqueous mixture). In some embodiments, the thixotropic aqueous mixture comprises a hydrophobically-modified smectite clay in an amount from 1.0 to 7.0% wt. % (percentage of the total weight of the thixotropic aqueous mixture).

In some embodiments, the at least one smectite clay is present in the thixotropic aqueous mixture in an amount from 1.0 to 6.0 wt. %, such as from 1.5 to 5.5 wt. %, from 1.0 to 5.0 wt. %, from 2.0 to 5.5 wt. %, or from 2.0 to 5.0 wt. % (percentage of the total weight of the thixotropic aqueous mixture).

In some embodiments, the thixotropic aqueous mixture comprises the at least one smectite clay in an amount from 0.5 to 4.5 wt. % (percentage of the total weight of the thixotropic aqueous mixture), such as from 0.5 to 3.5 wt. %, from 0.5 to 2.5 wt. %, from 1.0 to 2.5 wt. %; or from 1.0 to 4.0 wt. %, from 1.0 to 3.0 wt. %, from 1.5 to 3.5 wt. %, from 1.5 to 3.0 wt. %; or from 2.0 to 3.5 wt. % or from 2.0 to 3.0 wt. % (percentage of the total weight of the thixotropic aqueous mixture). In some embodiments, the thixotropic aqueous mixture comprises the at least one smectite clay in an amount of 2.0 to 3.0 wt. % (percentage of the total weight of the thixotropic aqueous mixture) by weight of the total thixotropic aqueous mixture. In some embodiments, the thixotropic aqueous mixture comprises the at least one smectite clay in an amount of or of about 2.4 wt. % (percentage of the total weight of the thixotropic aqueous mixture). For example, the thixotropic aqueous mixture may comprise montmorillonite (e.g., sodium montmorillonite) in an amount of 2.0 to 3.0 wt. %, such as about 2.4 wt. % (percentage of the total weight of the thixotropic aqueous mixture).

In some embodiments, the thixotropic aqueous mixture comprises the at least one smectite clay in an amount from 3.5 to 6.5 wt. % (percentage of the total weight of the thixotropic aqueous mixture), such as from 4.0 to 6.0 wt. %, from 4.0 to 5.5 wt. %; or from 4.5 to 6.0 wt. %, or from 4.5 to 5.5 wt. % (percentage of the total weight of the thixotropic aqueous mixture). In some embodiments, the thixotropic aqueous mixture comprises the at least one smectite clay in an amount of 4.5 to 5.5 wt. % (percentage of the total weight of the thixotropic aqueous mixture), In some embodiments, the thixotropic aqueous mixture comprises the at least one smectite clay in an amount of or of about 4.5 wt. %, or in an amount of or of about 5 wt. % (percentage of the total weight of the thixotropic aqueous mixture). For example, the thixotropic aqueous mixture may comprise bentonite (e.g., sodium bentonite) in an amount of 4.5 to 5.5 wt. %, such as in an amount of or of about 4.5 wt. %, or in an amount of or of about 5 wt. % (percentage of the total weight of the thixotropic aqueous mixture).

In some embodiments, the thixotropic aqueous mixture comprises the at least one smectite clay in an amount from 0.5 to 4.5 weight % by volume of the total thixotropic aqueous mixture composition. In some embodiments, the thixotropic aqueous mixture comprises the at least one smectite clay in an amount from 0.5 to 2.5 weight % by volume of the total thixotropic aqueous mixture composition.

The surface of (unmodified) smectite clay is partly or even substantially hydrophilic. Due to their hydrophilic nature, unmodified smectite clays do not disperse well within hydrophobic polymers and thus, preparation of a composition comprising a smectite clay and a hydrophobic polymer is challenging. A “hydrophobically-modified smectite clay”, as used herein, refers to a smectite clay that has been hydrophobically-modified (“hydrophobed”). The surface of a hydrophobically-modified smectite clay is substantially hydrophobic, and may be entirely hydrophobic. Accordingly, in some embodiments, a “hydrophobically-modified smectite clay” may be referred to as a “hydrophobic smectite clay”. Hydrophobically-modified smectite clay (e.g., hydrophobic smectite clay) has the advantageous feature of being oil or wax loving, as opposed to water loving. A known method of determining whether a smectite clay is hydrophobic or hydrophilic is to use a contact angle measurement. Using standard contact angle measurement equipment known in the art, the contact angle of water droplets on smectite clay can be measured. Water droplets form on hydrophobic surfaces, indicating that the cohesive forces associated within the droplet are greater than the forces associated with the interaction of water with the smectite clay surface. A contact angle greater than 90° between the surface of the smectite clay and the water droplet indicates that the clay is hydrophobic.

In some embodiments, the at least one smectite clay is, or has previously been, hydrophobically-modified (e.g., made hydrophobic) by treatment with a compatibilizing agent. In general, a “compatibilizing agent” is an organic modifier that reacts with a substance and hydrophobically-modifies the substance. In particular, the term “compatibilizing agent”, as used herein, refers to an agent that hydrophobically-modifies (“hydrophobes”) the smectite clay in the composition, thereby rendering the smectite clay “hydrophobically-modified”. Compatibilizing agents react with smectite clay to hydrophobically modify the smectite clay particles and thereby make the clay compatible with hydrophobic polymers. Specifically, compatibilizing agents react with the smectite clay by bonding to exchangeable sodium ions on the surface of the clay via ion-dipole bonding of the OH groups, thereby converting the smectite clay surface from hydrophilic to hydrophobic.

Ionic liquids are commonly used compatibilizing agents. Ionic liquids may be comprised of a combination of organic cations, including: ammonium, phosphonium, sulfonium, imidazolium, pyrrolidinium, piperidinium and/or pyridinium, with several organic and inorganic anions. Compatibilizing agents useful for preparing a hydrophobically-modified smectite clay of the invention include sodium citrate, mono- or di-glycerides of a natural fats, and/or mono- or di-esters of pentaerythritol. In some embodiments, the thixotropic composition of the invention comprises sodium citrate, which acts as both an antioxidant (as described herein) and as a compatibilizing agent for hydrophobically-modifying the smectite clay.

The thixotropic aqueous mixture of the invention comprises a water-soluble polymer. In some embodiments, the water-soluble polymer is a natural water-soluble polymer. The term “natural” or “naturally-occurring”, as used in this context, refers to a water-soluble polymer that occurs in nature, or is derived from nature, and is not made or caused by humankind. This term does not require the polymer to be “obtained directly from nature”. A “natural” or “naturally-occurring” water-soluble may be nature-identical but this is not essential. As the mixture is to be applied to produce, the water-soluble polymer is typically a food grade water-soluble polymer. The term “food grade”, as used herein, refers to a substance that is safe for human or animal consumption and that is permitted to come into direct contact with food meant for human or animal consumption. The water-soluble polymer is typically edible, meaning that it is safe for human or animal consumption.

In some embodiments, the water-soluble polymer is or comprises Gum Arabic or pectin, or combinations thereof. In some embodiments, the water-soluble polymer is Gum Arabic. In some embodiments, thixotropic aqueous mixture does not comprise the polymer PVOH; for example, in some embodiments the thixotropic aqueous mixture does not comprise any synthetic or semi-synthetic polymer.

In some embodiments, the thixotropic aqueous mixture comprises a water-soluble polymer (such as a natural water-soluble polymer) in an amount from 0.5 to 5.0 wt. % (percentage of the total weight of the thixotropic aqueous mixture). In some embodiments, the thixotropic aqueous mixture comprises Gum Arabic in an amount from 0.5 to 5.0 wt. % (percentage of the total weight of the thixotropic aqueous mixture). In some embodiments, the thixotropic aqueous mixture comprises pectin in an amount from 0.5 to 5.0 wt. % (percentage of the total weight of the thixotropic aqueous mixture).

In some embodiments, the thixotropic aqueous mixture comprises the water-soluble polymer in an amount from 0.5 to 4.5 wt. % (percentage of the total weight of the thixotropic aqueous mixture), such as from 0.5 to 4.0 wt. %, from 0.5 to 3.5 wt. %, from 0.5 to 3.0 wt. %, or from 0.5 to 2.5 wt. %; or from 1.0 to 3.5 wt. %, from 1.0 to 3.0 wt. %, or from 1.0 to 2.5 wt. % (percentage of the total weight of the thixotropic aqueous mixture). In some embodiments, the thixotropic aqueous mixture comprises the water-soluble polymer in an amount from 1.0 to 2.0 wt. % or 1.5 to 2.5 wt. % (percentage of the total weight of the thixotropic aqueous mixture). For example, the thixotropic aqueous mixture may comprise Gum Arabic in an amount from 1.0 to 2.0 wt. %, such as in an amount of 1.2 to 1.5 wt. % (percentage of the total weight of the thixotropic aqueous mixture). For example, the thixotropic aqueous mixture may comprise pectin in an amount from 1.5 to 2.5 wt. %, such as in an amount of or of about 1.9 wt. % (percentage of the total weight of the thixotropic aqueous mixture).

In some embodiments, the thixotropic aqueous mixture comprises the water-soluble polymer in an amount from 0.5 to 4.5 weight % by volume of the total thixotropic aqueous mixture composition. In some embodiments, the thixotropic aqueous mixture comprises the water-soluble polymer in an amount from 0.5 to 2.5 weight % by volume of the total thixotropic aqueous mixture composition.

In some embodiments, the thixotropic aqueous mixture comprises montmorillonite (e.g., sodium montmorillonite) and Gum Arabic. The thixotropic aqueous mixture in some embodiments comprises sodium montmorillonite from 1.0 to 7.0 wt. % and Gum Arabic from 0.5 to 2.0 wt. % (percentage of the total weight of the thixotropic aqueous mixture); such as 2.0-3.0 wt. % sodium montmorillonite and 0.5 to 1.5 wt. % Gum Arabic, or 4.0-6.0 wt. % sodium montmorillonite and 1.0 to 2.0 wt. % Gum Arabic. For example, the thixotropic aqueous mixture may comprise 2.4 wt. % sodium montmorillonite and 1.2 wt. % Gum Arabic. In another example, the thixotropic aqueous mixture may comprise 5.0 wt. % sodium montmorillonite and 1.5 wt. % Gum Arabic.

In some embodiments, the thixotropic aqueous mixture comprises bentonite (e.g., sodium bentonite) and Gum Arabic. The thixotropic aqueous mixture in some embodiments comprises bentonite from 1.0 to 7.0 wt. % and Gum Arabic from 0.5 to 2.0 wt. % (percentage of the total weight of the thixotropic aqueous mixture); such as 4.0-5.0 wt. % bentonite and 1.0 to 2.0 wt. % Gum Arabic. For example, the thixotropic aqueous mixture may comprise about 4.5 wt. % bentonite and 1.0 to 1.5 wt. % Gum Arabic.

In further embodiments, the thixotropic aqueous mixture comprises bentonite (e.g., sodium bentonite) and pectin. The thixotropic aqueous mixture in some embodiments comprises bentonite from 1.0 to 7.0 wt. % and pectin from 1.0 to 3.0 wt. % (percentage of the total weight of the thixotropic aqueous mixture); such as 4.0-5.0 wt. % bentonite and 1.0 to 2.5 wt. % pectin. For example, the thixotropic aqueous mixture may comprise about 4.3 wt. % bentonite and 1.5 to 2.0 wt. % pectin.

Various ratios of at least one smectite clay to water-soluble polymer are contemplated herein. In some embodiments, the weight ratio of at least one smectite clay to water-soluble polymer in the thixotropic aqueous mixture is between 1:4 and 4:1. In one embodiment, the ratio of at least one smectite clay to water-soluble polymer in the thixotropic aqueous mixture is between 3.5:1 and 1:1, such as about 3:1, 2:1, or 1:1.

In some embodiments, the thixotropic aqueous mixture further includes an antioxidant. In some embodiments, the antioxidant is a natural antioxidant or naturally-occurring antioxidant. The term “natural” or “naturally-occurring”, in this context, refers to an antioxidant that occurs in nature, or is derived from nature, and is not made or caused by humankind. This term does not require the antioxidant to be “obtained directly from nature”. A “natural” or “naturally-occurring” antioxidant may be nature-identical, but this is not essential. As the mixture is to be applied to produce, the antioxidant is typically a food grade antioxidant. The term “food grade”, as used herein, refers to a substance that is safe for human or animal consumption and that is permitted to come into direct contact with food meant for human or animal consumption. The antioxidant is typically edible, meaning that it is safe for human or animal consumption.

In some embodiments, the antioxidant is sodium citrate.

In some embodiments, the antioxidant is an antioxidant oil, which may be a naturally-occurring antioxidant oil. In some embodiments, the antioxidant oil is squalene.

In some embodiments, the thixotropic aqueous mixture comprises an antioxidant (e.g., a natural and/or food grade antioxidant) in an amount from 0.001 to 1.00 wt. % (percentage of the total weight of the thixotropic aqueous mixture). In some embodiments, the antioxidant is present in an amount from 0.01 to 1.00 wt. %, from 0.05 to 0.75 wt. %, or from 0.05 to 0.5 wt. %; or from 0.1 to 0.5 wt. %, from 0.1 to 0.4 wt. %, from 0.1 to 0.3 wt. %, or from 0.15 to 0.25 wt. % (percentage of the total weight of the thixotropic aqueous mixture). In some embodiments, the thixotropic aqueous mixture comprises an antioxidant in an amount of 0.1 to 0.2 wt. % (percentage of the total weight of the thixotropic aqueous mixture), In some embodiments, the thixotropic aqueous mixture comprises sodium citrate from 0.05 to 0.25 wt. % (percentage of the total weight of the thixotropic aqueous mixture); such as in an amount of 0.1 to 0.2 wt. %, or in an amount of or of about 0.2 wt. %.

In some embodiments, the thixotropic aqueous mixture comprises squalene at from 0.75 to 0.90% by weight of the total thixotropic aqueous mixture.

In some embodiments, the thixotropic aqueous mixture comprises a food grade antioxidant in an amount from 0.001 to 0.05 weight % by volume of the total composition.

In one embodiment, the thixotropic aqueous mixture comprises montmorillonite (e.g., sodium montmorillonite), Gum Arabic, and sodium citrate. The thixotropic aqueous mixture in some embodiments comprises montmorillonite from 1.0 to 7.0 wt. %, Gum Arabic from 0.5 to 2.0 wt. %, and sodium citrate from 0.1 to 0.5 wt. % (percentage of the total weight of the thixotropic aqueous mixture); such as 4.0-6.0 wt. % montmorillonite, 1.0 to 2.0 wt. % Gum Arabic, and 0.1-0.3 wt. % sodium citrate. In another example, the thixotropic aqueous mixture may comprise 5.0 wt. % sodium montmorillonite, 1.5 wt. % Gum Arabic, and 0.2 wt. % sodium citrate.

In one embodiment, the thixotropic aqueous mixture comprises bentonite (e.g., sodium bentonite), Gum Arabic, and sodium citrate. The thixotropic aqueous mixture in some embodiments comprises bentonite from 1.0 to 7.0 wt. %, Gum Arabic from 0.5 to 2.0 wt. %, and sodium citrate from 0.05 to 0.25 wt. % (percentage of the total weight of the thixotropic aqueous mixture); such as as 4.0-5.0 wt. % bentonite, 1.0 to 2.0 wt. % Gum Arabic, and 0.1 to 0.2 wt. % sodium citrate. For example, the thixotropic aqueous mixture may comprise about 4.5 wt. % bentonite, 1.3-1.4 wt. % Gum Arabic, and 0.1 to 0.2 wt. % sodium citrate (percentage of the total weight of the thixotropic aqueous mixture).

In one embodiment, the thixotropic aqueous mixture comprises bentonite (e.g., sodium bentonite), pectin, and sodium citrate. The thixotropic aqueous mixture in some embodiments comprises bentonite from 1.0 to 7.0 wt. %, pectin from 1.0 to 3.0 wt. %, and sodium citrate from 0.1 to 0.25 wt. % (percentage of the total weight of the thixotropic aqueous mixture); such as 4.0-5.0 wt. % bentonite, 1.0 to 2.5 wt. % pectin, and 0.1 to 0.2 wt. % sodium citrate. For example, the thixotropic aqueous mixture may comprise about 4.3 wt. % bentonite, about 1.9 wt. % pectin, and about 0.18 wt. % sodium citrate (percentage of the total weight of the thixotropic aqueous mixture).

The thixotropic aqueous mixture of the invention further comprises one or more solvents. As the mixture is to be applied to produce, the solvent is typically a food grade solvent. In one embodiment, the solvent is water. Alternatively, the solvent may comprise water and a volatile solvent such as ethanol, such as a mixture of water and ethanol.

In some embodiments, the solvent is present in an amount of at least 85 wt. % (percentage of the total weight of the thixotropic aqueous mixture), such as between 85 to 98 wt. %, or between 90 to 98 wt. %; optionally between 95 to 98 wt. % (percentage of the total weight of the thixotropic aqueous mixture). In some embodiments, the solvent is added to an amount of at least 90 wt. %, at least 95 wt. % or at least 97 wt. % (percentage of the total weight of the thixotropic aqueous mixture). In some embodiments, the mixture comprises 25 vol % ethanol and 75 vol % water.

In some embodiments, the thixotropic aqueous mixture comprises ethanol in an amount from 5 to 28 wt. % (percentage of the total weight of the thixotropic aqueous mixture), such as from 5 to 25 wt. % or 5 to 20 wt. %.

In some embodiments, the thixotropic aqueous mixture comprises a hydrophobically-modified (e.g., hydrophobic) smectite clay, a water-soluble polymer (such as a natural water-soluble polymer), an antioxidant (e.g., a natural and/or food grade antioxidant, such as a natural antioxidant oil), and a solvent (typically a food grade solvent). In some embodiments, the thixotropic aqueous mixture comprises a hydrophobically-modified (e.g., hydrophobic) smectite clay, a natural water-soluble polymer such as Gum Arabic or pectin, a natural and/or food grade antioxidant, and a food grade solvent. In any embodiments of the invention that use a hydrophobically-modified smectite clay, the solvent may comprise water and a volatile solvent (typically ethanol). For example, the thixotropic aqueous mixture may comprise hydrophobically-modified sodium montmorillonite or bentonite, Gum Arabic, sodium citrate, and a solvent comprising water and ethanol; or the thixotropic aqueous mixture may comprise hydrophobically-modified bentonite, Gum Arabic or pectin, sodium citrate, and a solvent comprising water and ethanol.

The invention further comprises a thixotropic mixture to protect produce such as pome fruit from superficial scald damage, comprising at least one hydrophobically modified smectite clay, a naturally occurring antioxidant oil, and a food grade solvent. Suitable hydrophobically-modified (e.g., hydrophobic) smectite clays for use in this mixture include hydrophobically-modified montmorillonite (e.g., sodium montmorillonite), bentonite, sodium hectorite, Laponite, or mixtures thereof. For example, the smectite clay may have been rendered hydrophobic by treatment with a compatibilizing agent, such as sodium citrate, or a mono or di glyceride or mono ester of pentaerythritol.

In some embodiments, the natural antioxidant oil is squalene, wherein the squalene is optionally present in small amounts such as at about 0.75 to 0.9 wt. % (percentage of the total weight of the thixotropic mixture). In these and other embodiments of the invention that employ a hydrophobically modified smectite clay, the solvent typically comprises ethanol. For example, ethanol may be present in the thixotropic mixture at 5 to 28 wt. % (percentage of the total weight of the thixotropic mixture).

In some embodiments of any of the thixotropic mixtures/compositions of the invention, the thixotropic mixture is an aqueous colloidal dispersion comprising between 1 and 7% solids; such as from 2 to 7% solids, from 3 to 7% solids, from 5 to 7% solids, or from 6 to 7% solids; or from 1 to 5% solids or 3 to 4% solids. In an aqueous colloidal dispersion, the solids (including the clay) are not dissolved in solution but are dispersed such that individual platelets of clay stay in colloidal dispersion. Aqueous colloidal dispersion is measured by drying out a known volume of dispersion and weighing the solid context of a mixture.

In some embodiments, the thixotropic mixture of the invention does not require additional components to achieve the desired outcome. For example, un some embodiments, the thixotropic mixture does not contain a calcium salt. Therefore, in some embodiments, there is provided a thixotropic aqueous mixture consisting of at least one smectite clay and a water-soluble polymer. In some embodiments, the thixotropic aqueous mixture consists of at least one smectite clay (e.g., a hydrophobic smectite clay (e.g., hydrophobically modified smectite clay)), a water-soluble polymer (such as a natural water-soluble polymer), an antioxidant (e.g., a natural antioxidant and/or a food grade antioxidant, such as a natural antioxidant oil), and a solvent (typically a food grade solvent, such a water or a mixture of water and ethanol).

In some embodiments, the thixotropic mixture is edible. The term “edible”, as used herein, refers to an item that is safe for human or animal consumption.

In some embodiments, the thixotropic mixture does not negatively modify the produce to which it is applied. For example, if the produce is organic, the thixotropic mixture is also organic. The term “organic”, as used herein, refers to components that, once applied to produce, would not change the organic status of produce. Thus, these components meet the standards set for organically produced agricultural products, such as the regulations for an “organic” claim set by the national organic program (NOP) of the U.S. Department of Agriculture (USDA). In some embodiments, an organic thixotropic aqueous mixture does not contain any inorganic components, where the term “inorganic”, as used herein, refers to components that, once applied to produce, would change the organic status of produce.

Thus, in some embodiments, the thixotropic aqueous mixture described herein is an edible, organic composition for preventing superficial scald and/or scuffing damage on produce. In some embodiments, the thixotropic aqueous mixture is an organic thixotropic aqueous mixture to protect organic fruit such as pears from scuffing damage, comprising at least one smectite clay and a natural water-soluble polymer. In some embodiments, the thixotropic aqueous mixture is an organic thixotropic aqueous mixture to protect pome fruit from superficial scald damage, comprising at least one smectite clay and a water-soluble polymer. In some embodiments, the thixotropic aqueous mixture is an organic thixotropic mixture to protect pome fruit from superficial scald damage comprising at least one hydrophobically-modified (e.g., hydrophobic) smectite clay, a naturally occurring antioxidant oil, and a food grade solvent.

The thixotropic mixtures are prepared by mixing together their individual components under high shear to form a thixotropic fluid, which may subsequently be applied to produce such as fruit or pome fruit (e.g., apples or pears). The thixotropic mixtures of the invention form a coating on the surface of produce, which to protects the produce from (e.g., prevents) damage caused by scuffing and/or superficial scald. Thus, in some embodiments, the thixotropic aqueous mixture described herein is a novel composition to prevent scuffing damage and/or superficial scalding of produce, such as fruit or pome fruit (e.g., apples and pears).

The invention also provides methods for making a thixotropic mixture of the invention, and mixtures made by these methods. The methods comprise high shear mixing.

In a second aspect, therefore the present invention provides a method of making a thixotropic aqueous mixture of the present invention. The method comprises mixing at least one smectite clay and a water-soluble polymer (such as a natural water-soluble polymer) with a solvent, under high shear, to form a thixotropic aqueous mixture.

The description and definitions provided herein in the context of the thixotropic mixtures of the invention also apply to methods of the invention for making a thixotropic mixture. In particular, the smectite clay, the water-soluble polymer, and the optional antioxidant used in the method can each be any of the smectite clays, water-soluble polymers, and antioxidants (respectively) described herein in the context of the thixotropic mixtures of the invention. Further, any of these smectite clays may be hydrophobically-modified, as described herein. In some embodiments, the solvent used in the method comprises or consists of water. In some embodiments, particularly in embodiments that involve a hydrophobically-modified smectite clay, the solvent comprises water and a volatile solvent (typically ethanol).

The methods of the invention for making a thixotropic mixture involve at least one step performed under high shear. Any of the methods or method steps described herein that involve high shear mixing may be carried out using any known high shear mixer, such as a vane mixer, Cowles dissolver, or colloid mill. High shear mixing requires equipment with high RPM and horsepower that ensure the dispersion blade can reach top speeds of between 2,500 to 5,000 feet per minute. The high shear mixing process may take 1-2 hours. For mixing of smaller batches of composition, a high shear blender may be used. High shear methods are advantageous because they achieve rapid mixing of the smectite clay and water-soluble polymer and/or other components in solvent to form a thixotropic mixture that ensures an even dispersal of smectite clay particles (platelets). When using standard mixing methods that do not involve high shear (such as a tank with paddle mixer), mixing of smectite clay and water-soluble polymer and/or other components in solvent will never fully disperse the smectite clay to form an evenly dispersed mixture. This is because the smectite clay platelets are held together in stacks by many weak bonds, such as hydrogen bonds and ion dipole interactions, which collectively amount to a large cohesive force. Standard mixing is not sufficient to overcome this cohesive energy. When using a method that involves high shear, the increased energy and substantial force imposed by the high shear is sufficient to break the forces that holds these smectite clay platelets together. Thus, a method of making the composition of the invention using high shear is highly efficient.

In some embodiments, the method comprises adding at least one smectite clay and a water-soluble polymer to water, followed by high shear mixing of the smectite clay, water-soluble-polymer, and water. In some embodiments, at least one smectite clay, a water-soluble polymer, and an antioxidant are added to water and mixed under high shear. In some embodiments, the method comprises adding at least one smectite clay and a water-soluble polymer to a mixture of water and ethanol, followed by high shear mixing of the smectite clay, water-soluble polymer, water, and ethanol. In some embodiments, at least one smectite clay (e.g., hydrophobic/hydrophobically-modified smectite clay), a water-soluble polymer, and an antioxidant are added to a mixture of water and ethanol and mixed under high shear.

In some embodiments, at least one smectite clay and a water-soluble polymer are mixed together in powder form, and then this smectite clay and water-soluble polymer “pre-mix” is added to the water, or to the mixture of water and ethanol, and mixed under high shear mixing conditions. In some embodiments, at least one smectite clay, a water-soluble polymer, and an antioxidant are mixed together in powder form, and then this smectite clay, water-soluble polymer, and antioxidant “pre-mix” is added to the water, or to the mixture of water and ethanol, and mixed under high shear mixing conditions. In some embodiments, the method comprises mixing together sodium montmorillonite or bentonite, Gum Arabic, and sodium citrate in powder form, and then this mixture is added to the water, or to the mixture of water and ethanol, and mixed under high shear mixing conditions. In some embodiments of these methods, the smectite clay is hydrophobically-modified (e.g., hydrophobic); and a solvent comprising water and ethanol may optionally be used.

In some embodiments, at least one smectite clay and a water-soluble polymer are added separately to the solvent (e.g., water or a mixture of water and ethanol) and then mixed under high shear. In some embodiments, an antioxidant (e.g., a natural and/or food grade antioxidant, such as a natural antioxidant oil) is also added separately to the solvent and mixed under high shear. In some embodiments, sodium montmorillonite or bentonite, Gum Arabic, and sodium citrate are added separately the solvent (e.g., water or a mixture of water and ethanol) and mixed under high shear mixing. In some embodiments of these methods, the smectite clay is hydrophobically-modified (e.g., hydrophobic); and a solvent comprising water and ethanol may optionally be used. In any of these embodiments, adding components “separately” to the solvent encompasses adding all components to the solvent simultaneously, adding two or more components simultaneously with one or more other components being added subsequently (simultaneously or sequentially), or adding each component sequentially.

As discussed herein, the antioxidant sodium citrate may also act as a compatibilizing agent to hydrophobically-modify the smectite clay. High shear mixing of the sodium citrate with the smectite clay in the presence of the solvent facilitates the mixing and reaction of the sodium citrate with the smectite clay to hydrophobically-modify the smectite clay and thereby form a hydrophobically-modified (e.g., hydrophobic) smectite clay (i.e., converts the smectite clay to a “hydrophobic smectite clay”), as described above.

In some embodiments of any of the methods of the invention for making a thixotropic composition, the smectite clay and the water-soluble polymer are added to the solvent at a ratio of between 1:4 and 4:1, such as at a ratio of between 3.5:1 and 1:1, such as about 3:1, 2:1, or 1:1 (wt/wt).

The invention also provides a thixotropic mixture made by any of the methods of the invention, such as a thixotropic aqueous mixture comprising at least one smectite clay, a water-soluble polymer, and optionally an antioxidant, and a solvent, each as described herein. The thixotropic composition made by any of the methods of the invention may be edible, and may optionally be organic. These terms have the meanings defined herein.

In some embodiments of any of the methods of making a thixotropic mixture of the invention, the method further comprises applying the thixotropic mixture to the surface of produce. For example, the mixture may be applied using a spray bar, dip tank, brush bed, ink jet printing, gravure, or doctor knife, or a combination thereof. For example, a thixotropic mixture made according to any of the methods of the invention may be applied to the surface of produce using a combination of a spray bar and brush bed, or using a dip tank and brush bed. In some embodiments, the thixotropic mixture is applied to the produce pre-harvest, but in other embodiments the thixotropic mixture is applied post-harvest. The method may further comprise drying the composition following application (e.g., by applying heat), but more typically the composition is left to dry naturally under ambient conditions. The thixotropic mixture forms a coating on the surface of the produce to which it is applied. The coating acts to protect the produce from superficial scald damage and/or from scuff damage.

The invention also provides methods in which a thixotropic mixture of the invention is applied to a surface of produce, to provide one or more technical effects as described herein. The description and definitions provided herein in the context of the thixotropic mixtures of the invention also apply to methods described below for protecting produce from scuffing damage and/or from superficial scald damage.

In a fourth aspect, therefore, the present invention provides a method of protecting produce from scuffing damage, comprising applying a thixotropic mixture of the invention to a surface of the produce.

In a fifth aspect, the present invention provides a method of protecting produce from superficial scald damage, comprising applying a thixotropic mixture of the invention to a surface of the produce.

The term “produce”, as used herein, refers to farm-produced crops. In some embodiments, the produce is fruit. In some embodiments, the produce is pome fruits, citrus fruits, or tomatoes. The invention is particularly applicable to pome fruits, more particularly apples, pears, and/or quince. In some embodiments relating to scuffing, the produce is pears. In some embodiments, the produce is vegetables. For example, the vegetable produce may be cucumbers or mushrooms.

Scuffing damage occurs, for example, during harvesting, sorting, and packaging of produce, particularly pome fruit such as apples and pears. Protecting produce from scuffing damage encompasses reducing or even preventing scuffing damage. A reduction in scuffing damage be defined in comparison to the scuffing damage of the same produce without any coating mixture (uncoated control), or in comparison to the scuffing damage of the same product coated with a conventional composition known in the art. Methods are known in the art for observing and measuring scuffing damage, for example, by image analysis or by eye to determine the percentage of scuffing damage on the produce. In some embodiments, produce (e.g., pears) coated with a thixotropic composition of the invention exhibits a substantial reduction in scuffing damage in comparison to the same produce (e.g., pears) coated with a conventional Carnauba wax coating, when assessed between 1-7 days post application. For example, in some embodiments, produce coated in a thixotropic mixture of the invention exhibits at least a 50% reduction in scuffing damage as compared to the same produce coated with a conventional control composition. In some embodiments, produce coated in a thixotropic mixture of the invention exhibits a reduction of scuffing damage and a slowing of ripening, as compared to conventionally-coated produce.

Superficial scald damage occurs, for example, during low-temperature storage of produce, particularly pome fruit such as apples and pears. Protecting produce from superficial scald damage encompasses reducing or even preventing superficial scald damage. A reduction in superficial scald damage be defined in comparison to the superficial scald damage of the same produce without any coating mixture (uncoated control), or in comparison to the superficial scald damage of the same product coated with a conventional composition known in the art. Methods are known in the art for observing and measuring superficial scald damage, for example, by image analysis or by eye to determine the percentage of superficial scald damage on the produce. For example, in some embodiments, pome fruit (e.g., pears) coated with a thixotropic aqueous mixture of the invention, when assessed between 1-7 days post application, are observed to have a substantial reduction in superficial scald damage in comparison to the same fruit (e.g., pears) coated with a conventional Carnauba wax-based composition. For example, when assessed 6 days post application, the percentage of pome fruit with less than 50% scald is at least as twice as high for fruit coated with a thixotropic aqueous mixture of the invention as compared to fruit coated with the conventional control composition. In some embodiments, pome fruit (e.g., pears) coated with a thixotropic aqueous mixture of the invention are observed to have superficial scald on less than 10% of the fruit surface when assessed between 5-7 days post application; whereas the same pome fruit (e.g., pears) coated with a conventional control composition displayed superficial scald on between 40-80% of the fruit surface, when assessed between 5-7 days post application. In further embodiments, a thixotropic aqueous composition of the invention prevents superficial scald of pome fruit. For example, in some embodiments, pome fruit (e.g., apples) coated with a thixotropic composition of the invention, when assessed 9 days post application, exhibit a complete lack of superficial scald; whereas the same fruit (e.g., apples) coated with Carnauba wax, when assessed 9 days post application, displayed superficial scald on between 30-40% of the fruit surface.

In some embodiments, the thixotropic mixture is applied to the produce pre-harvest, but in other embodiments the thixotropic mixture is applied post-harvest. Applying the mixture to produce pre-harvest has the advantage of providing protection from scuffing damage that may occur during the harvesting process. The maximum effect is seen when the thixotropic mixture is applied preharvest, but a substantial effect on superficial scald and scuffing damage is also seen if produce is coated after storage.

The thixotropic mixture used in the method for protecting produce from scuffing damage and/or from superficial scald damage can be any of the thixotropic mixtures of the invention described herein. In some embodiments, the thixotropic mixture used in the method for produce from scuffing damage and/or from superficial scald damage is a thixotropic aqueous mixture comprising at least one smectite clay (which may be hydrophobically-modified (e.g., hydrophobic) smectite clay) and a water-soluble polymer (such as a natural water-soluble polymer). In some embodiments, the thixotropic aqueous mixture comprises at least one smectite clay, a water-soluble polymer (such as a natural water-soluble polymer), and an antioxidant (e.g., a natural and/or food grade antioxidant, such as a natural antioxidant oil). The thixotropic mixture typically further comprises a solvent, which may comprise or consist of water, such as a mixture of water and ethanol, as defined herein. In some embodiments, the thixotropic mixture comprises at least one hydrophobically modified smectite clay, an antioxidant, and a solvent (optionally a mixture of water and ethanol). The terms “smectite clay”, “hydrophobically-modified smectite clay”, “water-soluble polymer”, “antioxidant”, and “solvent” are defined herein.

In some embodiments of the methods for protecting produce from scuffing damage and/or superficial scald damage, the thixotropic mixture is a thixotropic aqueous mixture comprising sodium montmorillonite or bentonite and Gum Arabic and is applied to produce, such as fruit or pome fruit (e.g., apples or pears), using a combination of spray bar and brush bed. In other embodiments, the thixotropic mixture is a thixotropic aqueous mixture comprising sodium montmorillonite or bentonite and Gum Arabic and is applied to produce, such as fruit or pome fruit (e.g., apples or pears), using a combination of a dip tank and brush bed. In some embodiments of the methods for protecting produce from scuffing damage and/or superficial scald damage, the thixotropic mixture is a thixotropic aqueous mixture comprising bentonite and pectin, and is applied to produce, such as fruit or pome fruit (e.g., apples or pears), using a combination of spray bar and brush bed. In other embodiments, the thixotropic mixture is a thixotropic aqueous mixture comprising bentonite and pectin, and is applied to produce, such as fruit or pome fruit (e.g., apples or pears), using a combination of a dip tank and brush bed. In any of these embodiments, the thixotropic aqueous mixture may further comprise an antioxidant, such as sodium citrate. The thixotropic mixture typically further comprises a solvent, which may comprise or consist of water, such as a mixture of water and ethanol, as defined herein. In any of these embodiments, the sodium montmorillonite or bentonite may be hydrophobically-modified.

In some embodiments of any of these methods of the invention for applying the thixotropic mixture to the surface of produce, or for protecting produce from scuffing damage and/or superficial scald damage, the thixotropic mixture is applied to the surface of the produce using a dip tank, spray bar, or brush bed, or any combination thereof.

A dip tank is a piece of equipment that houses 5000 to 10000 liters of thixotropic mixture of the invention and facilitates the submersion of produce, such as fruit or pome fruit (e.g., apples and pears), in order to coat their surface. When applying the thixotropic mixture to produce using the dip tank, the produce is dipped into the thixotropic mixture once with a residence time of 2 to 5 minutes of immersion. After application of the mixture using a dip tank, the produce may be placed onto a draining belt to remove excess mixture.

In some embodiments, the thixotropic mixture is applied to produce such as fruit or pome fruit (e.g., apples or pears) using a spray bar, optionally using a combination spray bar and brush bed. A spray bar is a piece of equipment comprising a pump and at least one nozzle for spraying thixotropic aqueous mixture onto produce. In the application stage, the shear imparted by the pump and spray nozzles of the spray bar lowers the viscosity of the thixotropic aqueous mixture and lessens the resistance to flow when applying the thixotropic aqueous mixture to produce, such as fruit or pome fruit (e.g., apples or pears). In some embodiments, the spray bar applies the thixotropic aqueous mixture to produce at a spray rate in the range of from 1000 to 7000 pounds of produce per liter of thixotropic mixture, such as in the range of 3000 to 7000 pounds of produce per liter of thixotropic mixture. Once the spray of the thixotropic aqueous mixture impinges upon the surface of the produce (i.e., the thixotropic aqueous mixture meets the surface of the produce), the viscosity recovers and forms a fairly thick coating on the produce. This advantageous feature, observed during the application of the thixotropic aqueous mixture of the invention, is due to the non-Newtonian fluid dynamics of the thixotropic mixture.

In some embodiments, the coating is applied by spraying using the spray bar after the dip tank and before the brush bed. For example, the thixotropic mixture may be sprayed onto the produce using a spray bar located after the produce exits the dip tank and draining belt, and/or optionally before the brush bed. The brush bed brushes each piece of produce following application of the thixotropic aqueous mixture to the surface of the produce. Brush beds normally have 6 to 12 brushes that are rolling, and act to both convey and brush the fruit. These brushes evenly and efficiently coat the fruit with the thixotropic mixture of the. The use of a brush bed is particularly advantageous because it ensures that there is an even coating of thixotropic aqueous mixture on the produce and avoids using excess mixture. Applying the thixotropic mixture of the invention using the combination of spray bar and brush bed is advantageous because it provides increased comprehensiveness of the coating.

In other embodiments, the thixotropic aqueous mixture is applied to produce via a combination of dip tank and brush bed, without spraying.

Prior to applying the thixotropic mixture, the produce may be washed in a dunk tank. A dunk tank is typically a 10000-liter tank used to introduce the fruit to the pack line and to wash the fruit and remove any debris, such as leaf and twigs. The use of a dunk tank is advantageous because it minimizes any damage which may be inflicted on the produce during these processes. The dunk tank and/or dip tank may contain a mild disinfectant, such as paracidic acid.

These methods for coating produce with a thixotropic aqueous mixture of the invention comprising at least one smectite clay and a water-soluble polymer (and optional antioxidant) are demonstrated to decrease the susceptibility of produce to scuffing and/or to superficial scald.

In a sixth aspect, the invention provides uses of any of the thixotropic mixtures of the invention. The invention provides the use of a thixotropic mixture of the invention for protecting produce from scuffing damage (e.g., for reducing or even preventing scuffing damage). The invention also provides the use of a thixotropic mixture of the invention for protecting produce from superficial scald damage (e.g., for reducing or even preventing superficial scald damage). In these uses of the invention, a reduction in scuffing damage and/or superficial scald damage may be determined in comparison to uncoated control produce or in comparison to the same produce coated with a conventional coating composition known in the art. In these uses of the invention, the produce is optionally fruit or vegetable produce. As discussed herein, the thixotropic mixture is particularly well suited for the protection of pome fruit, such as apples and pears. Therefore, in some embodiments, the invention provides the use of a thixotropic mixture of the invention for protecting pome fruit (e.g., apples and/or pears) from scuffing damage and/or from superficial scald damage. In any of these uses of the invention, the description and definitions provided herein in the context of the thixotropic mixtures of the invention also apply. Therefore, the thixotropic mixture used can be any of the thixotropic mixtures of the invention described herein.

### Example 1

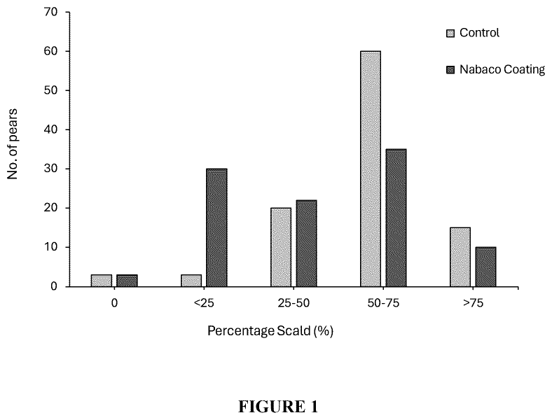

A commercial scale trial was conducted on Limonera pears in which “Nabaco Coated” Limonera pears were coated in a thixotropic aqueous mixture comprising 5% sodium montmorillonite, 1.5% Gum Arabic, and 0.2% sodium citrate in water (% values are by weight of the total composition), in comparison to “Control” Limonera pears coated in Carnauba wax. The thixotropic aqueous mixture was applied to 300 pounds of Limonera pears (Nabaco Coated) using a dip tank and brush bed and achieved an application rate of 3000 lbs of pears per liter of thixotropic aqueous mixture. The Carnauba wax was applied to the Control Limonera pears using a dip tank and brush bed at a solid content of 20%. After application of the thixotropic aqueous mixture, the Nabaco Coated and Control pears were sorted and packaged. The percentage of superficial scald at six days post-application was measured. Scuffing damage and/or superficial scald damage may be measured by image analysis or by eye to determine the percentage of scuffing and/or superficial scald damage. As shown in Table 1 and FIG. 1, the percentage of pears with less than 50% scald for the Control group of pears was 26% and for the Nabaco Coated pears was 55%. Thus, the thixotropic aqueous mixture of the invention reduces superficial scald in pears.

TABLE 1
Scald results for Limonera pears after six days.

| % Scald | Control | Nabaco Coated |
|---|---|---|
| 0% | 3 | 3 |
| <25% | 3 | 30 |
| 25-50% | 20 | 22 |
| 50-75% | 60 | 35 |
| >75% | 15 | 10 |

### Example 2

A second commercial scale trial was conducted on Bartlett pears in which “Nabaco Coated” Bartlett pears were coated in a thixotropic aqueous mixture comprising 2.4% sodium montmorillonite and 1.2% Gum Arabic in water (% values are by weight of the total composition), in comparison to “Control” Bartlett pears coated in Carnauba wax. The thixotropic aqueous mixture was applied to 5000 pounds of Bartlett pears (Nabaco Coated) with a spray bar and brush bed and achieved an application rate of 3000 lbs of pears per liter of thixotropic aqueous mixture, at a solid content of between 4 to 6%. The Carnauba wax was applied to the Control Bartlett pears using a spray bar and brush bed and achieved an application rate of 2500 lbs of pears per liter of Carnauba wax, at a solid content of 20%. After application of the thixotropic aqueous mixture or carnauba wax, the Nabaco Coated and Control pears were sorted and packaged. The degree of scuffing at three days post-application was determined to be 7 of the 25 pears from the Control group compared to 3 of the 25 pears from the Nabaco Coated pears, which are coated in the thixotropic aqueous mixture of the present invention. Therefore, this trial demonstrates a 57% reduction in scuffing damage in pears coated with the thixotropic aqueous mixture of the present invention.

### Example 3

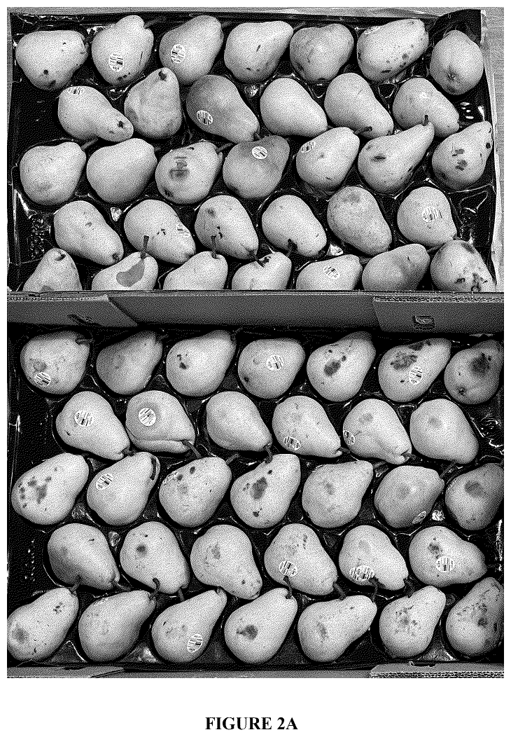

A line trial was conducted on Bartlett pears in which “Nabaco Coated” Bartlett pears were coated in a thixotropic aqueous mixture comprising 4.5% bentonite, 1.32% Gum Arabic, and 0.18% sodium citrate (% values are by weight of the total composition), in comparison to Control Bartlett pears coated in Carnauba wax. The thixotropic aqueous mixture was applied to the Nabaco Coated pears using a spray bar and brush bed and achieved an application rate of 7000 lbs of pears per liter of thixotropic aqueous mixture, at a solid content of between 4 to 6%. The Carnauba wax was applied to the Control pears using a spray bar and brush bed and achieved an application rate of 2500 lbs of pears per liter of Carnauba wax, at a solid content of 20%. After application of the thixotropic aqueous mixture or carnauba wax, the Nabaco Coated and Control pears were stored at ambient temperature for 9 days before the level of scuffing damage was observed. As shown in FIGS. 2A and 2B, the level of ripening was slowed and the degree scuffing damage was substantially reduced in Nabaco Coated pears (FIG. 2A) in comparison to Control pears (FIG. 2B). Therefore, this trial demonstrates a slowing of ripening and a reduction of scuffing damage in pears coated with the thixotropic aqueous mixture of the present invention.

### Example 4

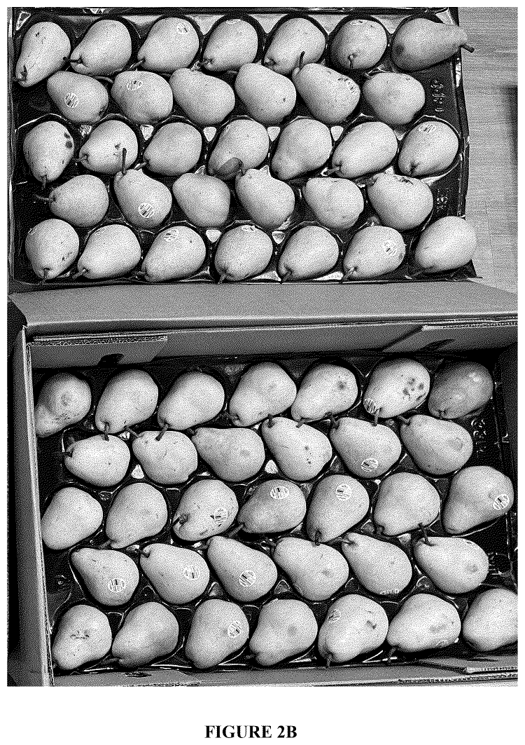

A further experiment was conducted on Granny Smith apples that had been stored in cold storage for 10 weeks in which “Nabaco Coated” Granny Smith apples were coated in a thixotropic aqueous mixture comprising 4.3% bentonite, 1.9% pectin, and 0.18% sodium citrate (% values are by weight of the total composition), in comparison to Control Granny Smith apples coated in Carnauba wax. The thixotropic aqueous mixture was applied to the Nabaco Coated apples using a spray bar and brush bed and achieved an application rate of 7000 lbs of apples per liter of thixotropic aqueous mixture, at a solid content of between 4 to 6%. The Carnauba wax was applied to the Control apples using a spray bar and brush bed and achieved an application rate of 2500 lbs of apples per liter of Carnauba wax, at a solid content of 20%. After application of the thixotropic aqueous mixture or carnauba wax, the Nabaco Coated and Control apples were stored at room temperature for 9 days before the level of superficial scald was observed. As shown in FIG. 3, the level of superficial scald on the Control apples covered 30-40% of the apples surface; whereas the Nabaco Coated apples exhibited no (0%) superficial scald. Therefore, this trial demonstrates a total reduction of superficial scald in apples coated with the thixotropic aqueous mixture of the present invention.

### Example 5

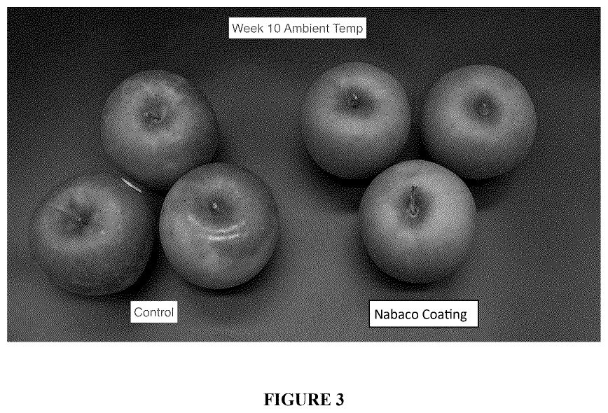

A further line trial was conducted on pears that had been in cold storage for 2 months, in which “Nabaco Coated” pears were coated in a thixotropic aqueous mixture comprising 4.5% bentonite, 1.32% Gum Arabic, and 0.18% sodium citrate (% values are by weight of the total composition), in comparison to Control pears coated in Carnauba wax. The thixotropic aqueous mixture was applied to the Nabaco Coated pears using a spray bar and brush bed and achieved an application rate of 7000 lbs of pears per liter of thixotropic aqueous mixture, at a solid content of between 4 to 6%. The Carnauba wax was applied to the Control pears using a spray bar and brush bed and achieved an application rate of 2500 lbs of pears per liter of Carnauba wax, at a solid content of 20%. After application of the thixotropic aqueous mixture, the Nabaco Coated and Control pears were stored at room temperature for 7 days before the level of superficial scald was observed. As shown in FIGS. 4A and 4B, the level of superficial scald on the Control pears covered 80% of the pears surface (FIG. 4A); whereas the Nabaco Coated pears demonstrated less than 10% superficial scald (FIG. 4B). Therefore, this trial demonstrates a reduction of superficial scald in pears coated with the thixotropic aqueous mixture of the present invention.

### Example 6

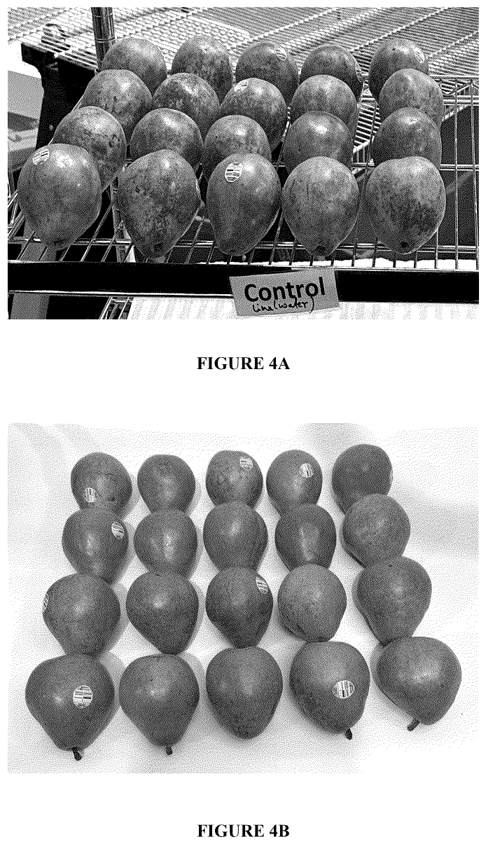

A commercial line trial was conducted on Bartlett pears that had been in cold storage for 30 days, in which “Nabaco Coated” Bartlett pears were coated in a thixotropic aqueous mixture comprising 4.6% bentonite, 1.4% Gum Arabic, and 0.15% sodium citrate (% values are by weight of the total composition), in comparison to Control Bartlett pears coated in Carnauba wax. The thixotropic aqueous mixture was applied to the Nabaco Coated pears using a spray bar and brush bed and achieved an application rate of 7000 lbs of pears per liter of thixotropic aqueous mixture, at a solid content of between 4 to 6%. The Carnauba wax was applied to the Control pears using a spray bar and brush bed and achieved an application rate of 2500 lbs of pears per liter of Carnauba wax, at a solid content of 20%. After application of the thixotropic aqueous mixture, the Nabaco Coated and Control pears were stored at room temperature for 5 days before the level of superficial scald was observed. As shown in FIGS. 5A and 5B, the Control pears demonstrated severe superficial scald on about 35% of pears and moderate superficial scald on 40-50% of pears; whereas the Nabaco Coated pears demonstrated less than 10% superficial scald. Therefore, this trial demonstrates a reduction of superficial scald in pears coated with the thixotropic aqueous mixture of the present invention.

### Example 7

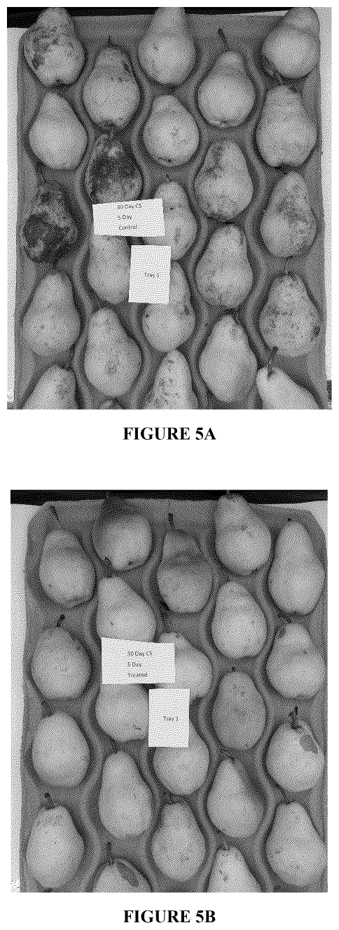

A pack line trial was conducted on Bartlett pears in which “Nabaco Coated” Bartlett pears were coated in a thixotropic aqueous mixture comprising 4.5% bentonite, 1.32% Gum Arabic, and 0.18% sodium citrate (% values are by weight of the total composition), in comparison to Control Bartlett pears coated in Carnauba wax. The thixotropic aqueous mixture was applied to the Nabaco Coated pears using a spray bar and brush bed and achieved an application rate of 7000 lbs of pears per liter of thixotropic aqueous mixture, at a solid content of between 4 to 6%. The Carnauba wax was applied to the Control pears using a spray bar and brush bed and achieved an application rate of 2500 lbs of pears per liter of Carnauba wax, at a solid content of 20%. After application of the thixotropic aqueous mixture, the percentage scuffing damage was measured at 1-, 3-, 5-, and 7-days post-application. As shown in FIG. 6, the Nabaco Coated pears demonstrated a substantial reduction in scuffing damage in comparison to the Control pears. Therefore, this pack line trial demonstrates a reduction of superficial scald in pears coated with the thixotropic aqueous mixture of the present invention.

### Example 8

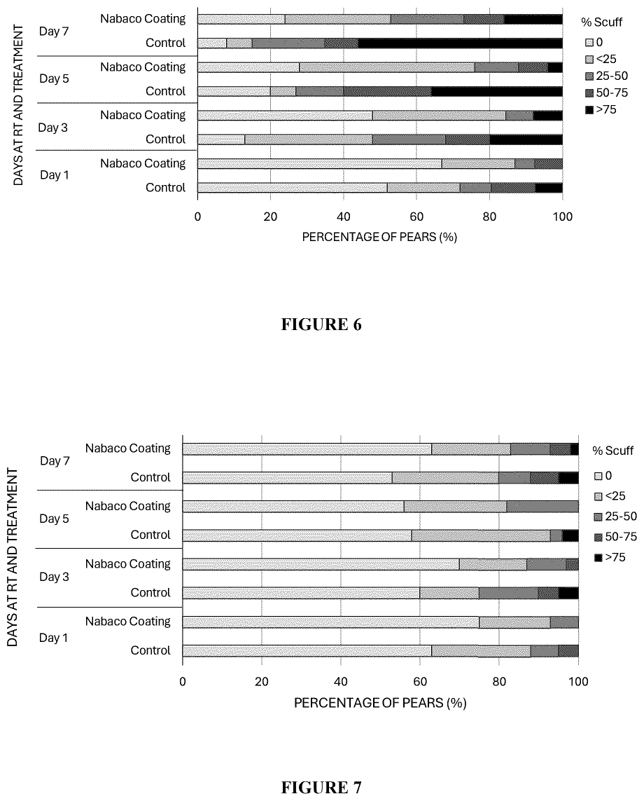

A pack line trial was conducted on D'Anjou pears in which “Nabaco Coated” D'Anjou pears were coated in a thixotropic aqueous mixture comprising 4.5% bentonite, 1.32% Gum Arabic, and 0.18% sodium citrate (% values are by weight of the total composition), in comparison to Control D'Anjou pears coated in Carnauba wax. The thixotropic aqueous mixture was applied to the Nabaco Coated pears using a spray bar and brush bed and achieved an application rate of 7000 lbs of pears per liter of thixotropic aqueous mixture, at a solid content of between 4 to 6%. The Carnauba wax was applied to the Control pears using a spray bar and brush bed and achieved an application rate of 2500 lbs of pears per liter of Carnauba wax, at a solid content of 20%. After application of the thixotropic aqueous mixture, the percentage scuffing damage was measured at 1-, 3-, 5-, and 7-days post-application. As shown in FIG. 7, the Nabaco Coated pears demonstrated a substantial reduction in scuffing damage in comparison to the Control pears. Therefore, this pack line trial demonstrates a reduction of superficial scald in pears coated with the thixotropic aqueous mixture of the present invention.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

1. A thixotropic aqueous mixture for protecting produce from scuffing damage and/or superficial scald damage, comprising at least one smectite clay and a water-soluble polymer.

2. The thixotropic aqueous mixture of claim 1, wherein the at least one smectite clay is from 1 to 7 wt. %, optionally from 2 to 6 wt. %.

3. The thixotropic aqueous mixture of claim 1 or claim 2, wherein the at least one smectite clay is montmorillonite, bentonite, hectorite, or Laponite, or a mixture of any two or more thereof.

4. The thixotropic aqueous mixture of claim 3, wherein the at least one smectite clay is sodium montmorillonite or bentonite.

5. The thixotropic aqueous mixture of any one of claims 1-4, wherein the at least one smectite clay is hydrophobically-modified.

6. The thixotropic aqueous mixture of any one of claims 1-5, wherein the water-soluble polymer is Gum Arabic or pectin.

7. The thixotropic aqueous mixture of any one of claims 1-6, wherein the water-soluble polymer is from 0.5 to 5.0% wt. %, optionally from 1 to 2.5 wt. %.

8. The thixotropic aqueous mixture of any one of claims 1-7, wherein the ratio of at least one smectite clay to water-soluble polymer is between 1:4 and 4:1; optionally wherein the ratio of at least one smectite clay to water-soluble polymer is about to 1:1.

9. The thixotropic aqueous mixture of any one of claims 1-8, further comprising an antioxidant.

10. The thixotropic aqueous mixture of claim 9, wherein the antioxidant is sodium citrate.

11. The thixotropic aqueous mixture of claim 9 or claim 10, wherein the antioxidant is from 0.05 to 0.5 wt. %.

12. The thixotropic aqueous mixture of claim 9, wherein the antioxidant is an antioxidant oil, optionally squalene.

13. The thixotropic aqueous mixture of any one of claims 1-12, further comprising a solvent.

14. The thixotropic aqueous mixture of claim 13, wherein the solvent comprises or consists of water; optionally wherein the solvent comprises a mixture of water and ethanol.

15. The thixotropic aqueous mixture of any one of claims 1-14, wherein the aqueous thixotropic mixture is an aqueous colloidal dispersion comprising between 1 and 7% solids.

16. The thixotropic aqueous mixture of any one of claims 1-15, wherein the mixture is organic.

17. A method of making a thixotropic aqueous mixture, comprising mixing at least one smectite clay and a water-soluble polymer with solvent under high shear to form a thixotropic mixture.

18. The method of claim 17, wherein the solvent comprises or consists of water; optionally wherein the solvent comprises a mixture of water and ethanol.

19. The method of claim 17 or claim 18, wherein the at least one smectite clay is montmorillonite, bentonite, hectorite, or Laponite, or a mixture of any two or more thereof; optionally wherein the at least one smectite clay is sodium montmorillonite or bentonite; optionally wherein the at least one smectite clay is hydrophobically-modified.

20. The method of any one of claims 17-19, wherein the water-soluble polymer is Gum Arabic or pectin.

21. The method of any one of claims 17-20, wherein the at least one smectite clay and the water-soluble polymer are combined in powder form, and then the combined powders are mixed with solvent under high shear.

22. The method of any one of claims 17-20, wherein the at least one smectite clay and the water-soluble polymer are added separately to the solvent during high shear mixing.

23. The method of any one of claims 17-22, further comprising mixing an antioxidant with the at least one smectite clay and water-soluble polymer in the solvent under high shear.

24. A thixotropic composition prepared by the method of any of claims 17-23.

25. A method, comprising:
i) making a thixotropic mixture using a method according to any one of claims 17-23; and
ii) applying said thixotropic aqueous mixture to the surface of produce via a dip tank, spray bar, or brush bed, or any combination thereof.

26. A method of protecting produce from scuffing damage, comprising applying the thixotropic aqueous mixture of any one of claim 1-16 or 24 to the surface of produce.

27. A method of protecting produce from superficial scald damage, comprising applying the thixotropic aqueous mixture of any one of claim 1-16 or 24 to the surface of produce.

28. The method of claim 26 or 27, wherein the thixotropic aqueous mixture is applied via a dip tank, spray bar, or brush bed, or any combination thereof.

29. The method of claim 25 or 28, wherein the thixotropic aqueous mixture is applied using a combination of spray bar and brush bed, or using a combination of dip tank and brush bed.

30. The method of any one of claim 25, 28, or 29, wherein the spray bar applies the thixotropic aqueous mixture to produce at a spray rate in the range of 3000 to 7000 pounds of produce per liter of thixotropic aqueous mixture.

31. Use of the thixotropic aqueous mixture of any of claim 1-16 or 24 for protecting produce from scuffing damage.

32. Use of the thixotropic aqueous mixture of any of claim 1-16 or 24 for protecting produce from superficial scald damage.

33. The method of any one of claim 25 or 26-30, or the use of claim 31 or 32, wherein the produce is fruit; optionally pome fruit.
